(19) United States
(12) Patent Application Publication
(10) Pub. No.: US 2012/0148092 A1
(43) Pub. Date: Jun. 14, 2012

(54) AUTOMATIC TRAFFIC VIOLATION DETECTION SYSTEM AND METHOD OF THE SAME

(75) Inventors: SZE-YAO NI, TAIPEI CITY (TW); YUANG-TZONG LAN, TAIPEI CITY (TW); TOM C.I. LIN, TAIPEI CITY (TW); YI-WEI CHEN, TAIPEI CITY (TW)

(73) Assignee: GORILLA TECHNOLOGY INC., TAIPEI CITY (TW)

(21) Appl. No.: 12/963,861

(22) Filed: Dec. 9, 2010

(51) Int. Cl. G06K 9/00

(52) U.S. Cl. 382/103

(57) ABSTRACT

Disclosed herein are a system and method for the automatic detection of traffic and parking violations. Camera input is digitally analyzed for vehicle type and location. This information is then processed against local traffic and parking regulations to detect violations. Detectable driving offenses include, but are not limited to: no scooters, buses only, and scooters only lane violations. Detectable parking offenses include, but are not limited to: parking or loitering in bus stops, parking next to fire hydrants, and parking in no-parking zones. Camera input, detected vehicle information, and violations can be stored for later search and retrieval. The system may be configured to signal the authorities or other automated analysis systems about specific violations. When coupled with automatic license plate recognition, vehicles may be automatically matched against a registration database and reported or ticketed.

### BACKGROUND OF THE INVENTION

1. Field of the Invention

The instant disclosure relates to a visualized automatic traffic violation detection system and a related method, more particularly, to a traffic violation detection system employing image analysis techniques to detect the violations such as illegal driving, illegal occupation, and illegal parking.

2. Description of Related Art

Determination of illegal driving in traffic violation detection is one of the most important topics. The traffic violation detection may be used to detect the driving on a wrong designated lane, including scooter-prohibited lane, bus-only lane, freeway shoulder, and scooter-only lane. If prohibited vehicle runs on a designated lane, the offense may result in a traffic accident. For example, the violations, such as the scooter waiting zone occupied by vehicle rather than scooter, and the reserved bus stops occupied by other vehicles, may lead to infringe upon the right of road usage of other drivers or serious traffic problems. The example of the illegal occupation at a specific zone such as the region around fire hydrant may seriously impede emergency relief and hazard public safety. Therefore, any effective detection of the illegal driving or occupation could be helpful to the public safety.

Currently, taking pictures manually at a specific location is most general way to expose the offense of traffic regulation. However, this conventional way provides poor efficiency since it requires high cost of manpower and there is no automatic process to assist for all day long detection. For deterring the traffic violations effectively, the conventional way need to become efficiency.

In order to eliminate the mentioned drawbacks, provided in the instant disclosure is a visualized automatic detection method for detecting the offenses regarding to the traffic violation. This automatic detection approach may recognize the vehicles against the traffic regulations, and store the images of violation events as the evidence for ticketing the traffic violations.

### SUMMARY OF THE INVENTION

Provided is an automatic traffic violation detection system and a method thereof. By means of digital image processing technology, the system analyzes the vehicle information in monitoring images. Based on the traffic regulation and the predetermined detection zone in the system, the illegal driving against the regulation can be detected. The monitoring image related to violating vehicle can be outputted to any designated device.

Through one or more cameras, a specific zone is monitored and photographed. The monitoring image related to the specific zone, such as a designated lane, can be acquired. The mentioned digital image processing technology is employed on the image taken by the camera(s), and the position and movement information of vehicles can be identified. By an image recognition technology, the types of the vehicles in the image can be identified, including large vehicles, cars and scooters. When any illegal driving event is detected, the traffic violation detection system outputs the related information identified by system to the designated device.

In particular, the claimed automatic traffic violation detection system may be adapted to the detections of the illegal driving such as the scooter running on the scooter-prohibited lane, the vehicle driving on the freeway shoulder, any general vehicle running on the bus-only lane, and the car traveling on the scooter-only lane. Furthermore, the system may also be applied to detect the behaviors against the traffic regulations, for example, the scooter waiting zone are occupied by other types of vehicles, and the designated zones, such as an intersection, the bus stop zone, the area around the fire hydrant, the exit of fire-fighting truck, are occupied by any vehicle.

The main feature of the claimed system is saving the manpower consumption of long time manual surveillance at sites. Furthermore, the license plate recognition technique may be incorporated with the claimed system for recognizing the license-plate of violating vehicles as any offense is detected. The results of the license plate recognition and the related monitoring image may be outputted together for storage in the designated device. The stored data can be referred with the benefit of hindsight report of the traffic violations.

Still further, the claimed system may be joined with an event tagging function. This function records the date, time, location, and the type of offense as event tagged data. The records in the storage can be referred to any further hindsight analysis or filtering monitoring images. Users may fast filter or find out the illegal driving event from the event tagged data.

According to one of the embodiments, the traffic violation automatic detection method starts with a step of establishing a conditional data group contains information about the detection zone and vehicle-type for violation detection. Referred to the traffic regulation, the condition used in offense determining unit can be defined by the conditional data group. When the offense determining unit receives the position and type information of detected vehicles, the method is then to determine whether the vehicle enters the detection zone according to the position information. If the vehicle is not entering the detection zone, no traffic offense is detected; if the vehicle enters the detection zone, the method further determines whether the vehicle is the prohibited vehicle-type based on the vehicle-type information and preset conditional data group. Since the offense determining unit determines that the vehicle is violating the regulation, a data output unit is informed to further outputting.

Furthermore, according to another embodiment, when the offense determining unit receives the position and type information of detected vehicles, the method is to determine whether the vehicle violates the regulation of occupation or parking regulations by checking if the prohibited vehicle occupies the predefined zone over the predefined detection period.

These and other various advantages and features of the instant disclosure will become apparent from the following description and claims, in conjunction with the appended drawings.

### BRIEF DESCRIPTION OF THE DRAWINGS

FIG. 1 illustrates a process related to the architecture of present invention;

FIG. 2 shows a schematic diagram of the embodiment of image analysis unit in accordance with the present invention;

FIG. 3 is a flow chart illustrating the offense determination of one embodiment in accordance with the present invention;

FIG. 4 is a flow chart illustrating the offense determination of another embodiment in accordance with the present invention;

FIG. 5 illustrates a flow chart of the detection method in one embodiment in accordance with the present invention;

FIG. 6 illustrates a flow chart of the detection method in another embodiment in accordance with the present invention;

FIG. 7 shows one embodiment of the architecture of the present invention;

FIG. 8 shows another embodiment of the architecture of the present invention.

### DETAILED DESCRIPTION OF THE PREFERRED EMBODIMENTS

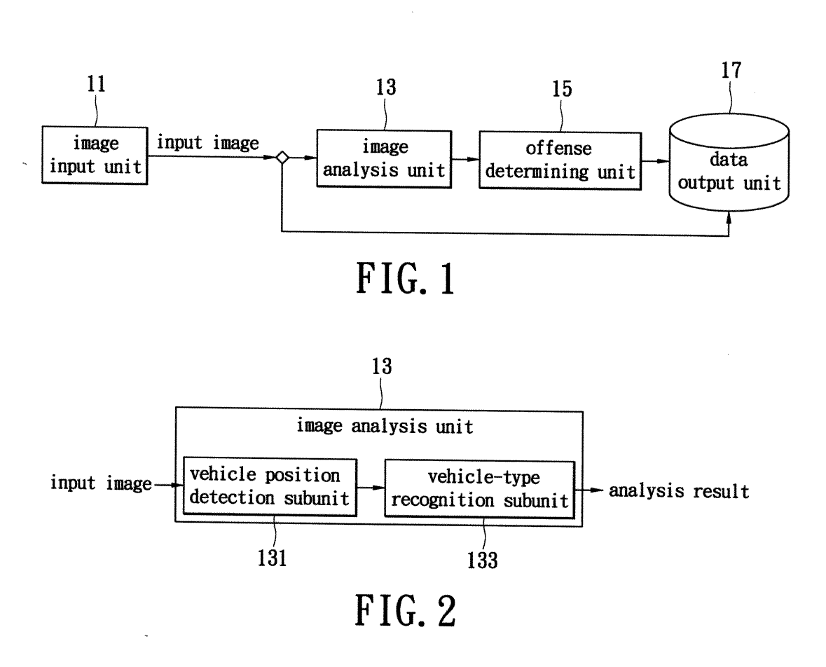

Reference is made to FIG. 1 depicting a functional diagram of an example of the automatic traffic violation detection system. The system essentially includes an image input unit 11, an image analysis unit 13, an offense determining unit 15, and a data output unit 17. The image input unit 11 functions to receive the monitoring image. The image analysis unit 13 is connected to the image input unit 11, and used for analyzing and extracting the type and position information of vehicles. The offense determining unit 15 is connected to the image analysis unit 13, and used to determine if any offense occurs. The data output unit 17 is connected to the offense determining unit 15, and used for outputting the data of the violating vehicle(s).

After the monitoring image is acquired by the image input unit 11, the image is transferred to the image analysis unit 13. By conducting image analysis techniques, the type and position information of all vehicles can be extracted. Based on the vehicle-type and position information, the offense determining unit 15 determines whether the behavior of the vehicle in the image violates the predefined traffic regulation. If any traffic violation is determined, the data output unit 17 outputs the data of violating vehicle including images and related information.

In accordance with the disclosure, the image input unit 11 can be implemented as one or in combination of cameras or other image output equipments, such as a digital video recorder, digital camera, video player and digital image files. It particularly provides the monitoring image for detection on a specific zone. In one embodiment, the image input unit 11 can be a wide-angle camera, a license plate camera, or in combination of any number of the wide-angle cameras and the license plate cameras.

In an exemplary embodiment, the data output unit 17 can be a storage device, a display, data transmission equipments, or any combination of these devices. One of the objects is to provide an instant warning regarding to traffic violation or a use with the benefit of hindsight report or ticketing.

Reference is made to FIG. 2 describing an image analysis unit 13 of the automatic traffic violation detection system of the disclosure. The image analysis unit 13 includes a vehicle position detection sub-unit 131 and a vehicle-type recognition sub-unit 133. The vehicle position detection sub-unit 131 is employed to extract the position and movement information of the vehicle from the taken image sequence. The vehicle-type recognition sub-unit 133 is used to extract the vehicle-type information from the image sequence; the vehicle-type includes scooter, car, bus, etc.

The mentioned vehicle position detection sub-unit 131 incorporated in the automatic traffic violation detection system may be implemented by, but not limited to, several approaches as follows:

In one of the embodiments, the acquired image can be divided into several sub-blocks based on the color. For all sub-blocks, the motion vectors of them are estimated. When the distance between two sub-blocks is smaller than a threshold and the motion vectors of these sub-blocks are similar, these sub-blocks are merged into an image object. Furthermore, the position and movement information of object can be extracted.

The vehicle image can be detected by the other approach, for example, a background image is firstly generated based on an input image sequence. Through comparing the difference between the current image and the background image, the vehicle image is extracted from the image sequence. The position and movement information related to vehicles are further obtained.

According to one further embodiment of the disclosure, an object tracing algorithm is particularly adapted to extract the movement information of the vehicle.

The vehicle-type recognition sub-unit 133 of the automatic traffic violation detection system in accordance with the disclosure may be implemented, but not limited to, as one of following embodiments.

In one embodiment, the various features extracted from the vehicle images including the vehicle's aspect ratio, moving speed and contour can be referred for classifying the vehicles in the vehicle-type recognition sub-unit 133. For example, the vehicle may be identified as a scooter since the vehicle image of extracted object has large aspect ratio and the area occupied by the vehicle in the image is small. Rather than the scooter's feature, the vehicle is a car when the aspect ratio is smaller and the object is moving in high speed. Furthermore, in one further embodiment, the detected object is compared with a plurality of vehicle templates include scooter templates, car templates, bus templates, etc. If the features extracted from the vehicle image are very similar to a specific template, the vehicle may be classified as the type corresponding to the template. Through the pattern recognizing scheme conducted by the vehicle-type recognition sub-unit 133, the detection system may identify the detected vehicles as scooter, car, bus or other types.

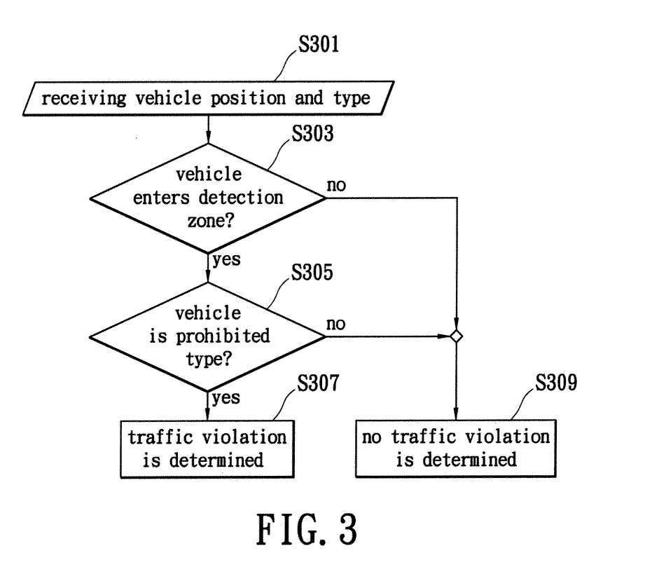

A flow chart illustrating the offense determining unit of the automatic traffic violation detection system is shown in FIG. 3. In particular, this disclosure is applicable to detect the traffic violation of a vehicle running in the prohibited lane.

The offense determining unit may be implemented, but not limited to, as one of the following approaches.

In one embodiment, the offense determining unit employs the output information of the image analysis unit to determine whether the vehicle violates any traffic regulation. In the beginning, the detection system establishes a conditional data group including the information about a predefined detection zone and some related vehicle-type information. The system then resolves the condition of determination based on the information in the data group and the traffic regulation. When the offense determining unit receives the position and type information of vehicles (step S301), the system can firstly determines if any vehicle enters the detection zone referred to the predefined detection zone (step S303). If there is no vehicle entering the detection zone (no), it is determined that there is no behavior against the regulation (step S309). If there is a vehicle entering the detection zone (yes), the next step is to determine if the vehicle type to drive in the lane is prohibited according to the vehicle-type information (step S305). Based on the determination, the traffic violation is verified (step S307) as the type of vehicle is prohibited one. If the vehicle type is not prohibited, it is determined that its behavior may not violate the traffic regulation (step S309). When the traffic violation is verified by the offense determining unit, the related information is inputted to a data output unit for further data outputting.

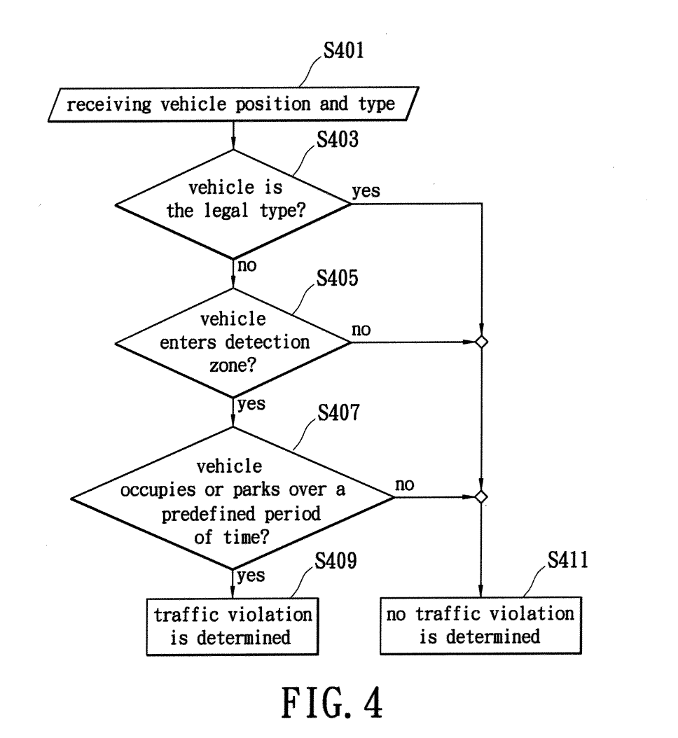

Further reference is made to FIG. 4, which illustrates another flow chart of offense determining unit of the detection system in accordance with the present invention. This implement of the offense determining unit is applicable to detect the offense of illegal occupation of a lane or a designated zone.

The mentioned offense determining unit may be implemented as, but not limited to, one of the following schemes. When the offense determining unit receives the position information and type of the vehicle (step S401), the first step is to determine whether the vehicle is the type legally occupying or parking according to the traffic regulation (step S403). If so, the behavior of the vehicle does not violate the traffic regulation (step S411); if not, the offense determining unit continuously determines whether the vehicle enters the detection zone (step S405). If the vehicle does not enter the zone, it means there is no traffic violation (step S411); if the vehicle enters the zone, the next step is determining whether the vehicle occupies or parks at the detection zone over the predefined period (step S407). If so, the determination unit verifies the vehicle violates the traffic regulation (step S409); if not, it means there is no traffic violation (step S411). After the above steps are performed by the offense determining unit, the violating vehicles can be detected. At the end, the result is further transferred to the data output unit for outputting data includes images and related information.

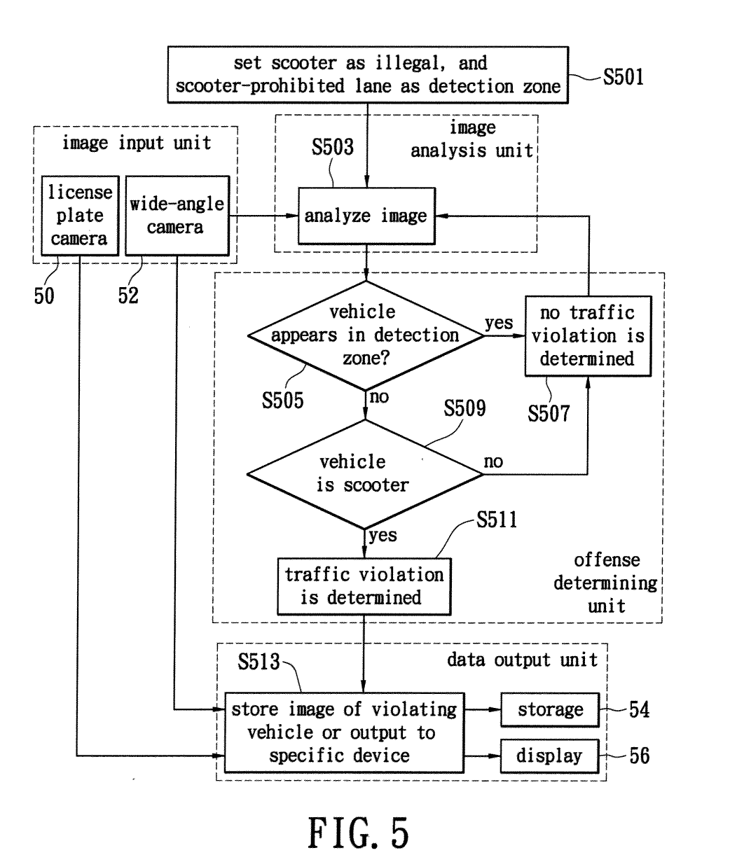

Further reference is made to FIG. 5 showing an application of the automatic traffic violation detection system. This detection system is adapted to detect the offense of the scooter running on the scooter-prohibited lane.

Herein, an image input unit is a combination of a wide-angle camera 52, and several license plate cameras 50 (each of them is focused on a specified lane). Any image acquiring device which can be used to taking the image of the license plate can be introduced, for example a digital camera. The wide-angle camera 52 is preferably used to take the image of the lanes under monitored. The license plate camera 50 or other image acquiring device may be used to take the image of license plate of the violating vehicle.

Firstly, a detection zone with respect to the image of scooter-prohibited lane is set in the system. The vehicle-type is configured to be the scooter which is prohibited to drive on the detection zone (step S501). The wide-angle camera 52 captures the image sequence contains the scooter-prohibited lane. The taken image sequence is outputted form the image input unit. After that, the image analysis unit analyzes the images (step S503) to extract the type and position information of each vehicle. The detected vehicle information is then inputted to the offense determining unit. Based on the previous configuration, the offense determining unit sequentially determines if any detected vehicle is against the traffic regulation.

At first, the unit determines whether any vehicle appears within the detection zone (step S505). If there is no vehicle appeared in the detection zone, it is determined that there is no traffic violation (step S507); if any vehicle appears in the detection zone, the next step is to determine whether the vehicle is a scooter according to the vehicle-type information (step S509). If the vehicle is a scooter, it is an offense according to the traffic regulation (step S511); if the vehicle is not a scooter, it is determined the vehicle obeys the traffic regulation (step S507).

If a traffic violation is determined by the offense determining unit, the related information is outputted and the data output unit is activated. In an exemplary example, the data output unit includes a storage device 54 and a display device 56. If the data output unit receives the information with respect to a traffic violation from the offense determining unit, the related information preferably includes the images such as an image captured by wide-angle camera contains violating vehicle and an image captured license plate camera contains violating vehicle's license plate. The images are concurrently shown on a display device 56 for warning. The data output unit also stores the data regarding the traffic violation into storage 54, or outputs to a specific device (step S513). Those images can be used to be the evidence with the benefit of reporting or ticketing.

According to another embodiment, the detection system can be used for detecting the violations including vehicle driving on a freeway shoulder, a regular car running on a bus-only lane, and a car running on the scooter-only lane.

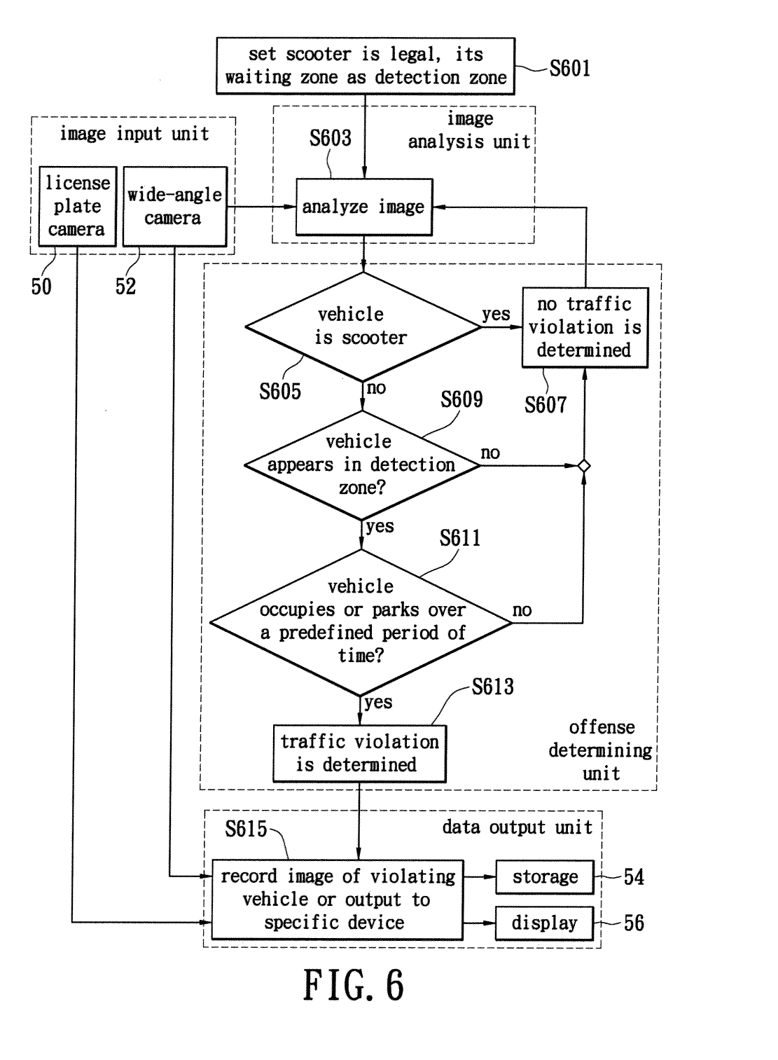

FIG. 6 shows another exemplary example of the automatic traffic violation detection system in accordance with the present invention. Detection of the traffic violation such as the non-scooter occupying the scooter-waiting zone is disclosed.

Herein, an image input unit is a combination of a wide-angle camera 52, and several license plate cameras 50 (each of them is focused on a specified lane). Any image acquiring device which can be used to taking the image of the license plate is alternatively introduced into the system, for example, a digital camera. The wide-angle camera 52 is used to take the image of the lane to be monitored. The license plate camera 50 or the image acquiring device is used to acquire the image of license plate of the violating vehicle.

Through the system, the zone with respect to the scooter waiting zone is configured to be a detection zone in advance. Furthermore, the type of vehicle allowed to occupy the detection zone is set as scooter (step S601). The wide-angle camera 52 is to take the image of the lanes including the scooter waiting zone. After the image input unit receives the image, the image analysis unit analyzes the image (step S603) to extract the type and position information of each vehicle from the image sequence. The detected vehicle information is then outputted to the offense determining unit.

Next, the offense determining unit, based on the configuration, determines that whether the behavior of any detected vehicle is against the traffic regulation. The offense determining unit firstly determines if the vehicle is a scooter (step S605). If the vehicle is a scooter, it is determined that there is no traffic violation (step S607); if the vehicle is not a scooter, the next step is to determine whether the vehicle appears in the detection zone (step S609). If the vehicle is not in the detection zone, it is determined that there is no traffic violation (step S607); if the vehicle is in the detection zone, the unit determines whether the vehicle occupies the scooter waiting zone over a predefined period (step S611). If the time of occupation exceeds the predefined period, it is determined that the vehicle violates the traffic regulation (step S613); if not, there is no traffic violation (step S607).

Furthermore, when the offense determining unit determines the behavior of the vehicle is against traffic regulation. The result is further transferred to the data output unit for outputting the related data. In this example, the data output unit includes a storage device 54 and a display device 56. When the data output unit receives the information of traffic violation from the offense determining unit, the display device 56 may instantly show the images including the wide-angle image and the image of license plate of the vehicle. Therefore, the system implements for real-time warning.

In the meantime, the data output unit outputs the data with respect to the traffic event and records it into a storage device 54 (step S615) with the benefit of hindsight report or ticketing. In an example, the detection system also acquires the traffic signals from the traffic light. When the traffic light is in condition of red light, the detection process starts to detect if there is any violation of illegal occupation of scooter waiting zone by any non-scooter vehicle.

In one preferred embodiment, the automatic traffic violation detection system is also used to detect the event as any regular vehicle parks on the unallowable locations such as an intersection, in 10 meters of a bus stop, a position near fire hydrant, and in 5 meters near the entrance of a fire-fighting truck. The system allows users to define the allowable occupation, parking time limit, or/and the type of vehicle according to the traffic regulation. The system then accordingly performs the detection of the offense.

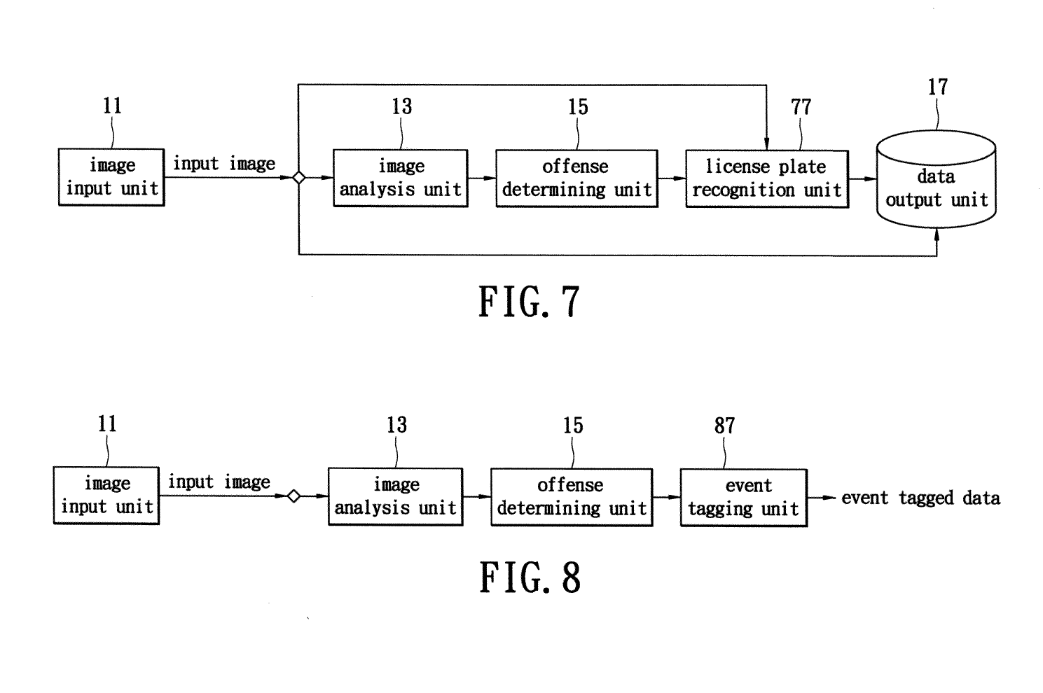

Another example of the claimed detection system is shown in FIG. 7. The system in this example, as referred to FIG. 1, includes the image input unit 11, the image analysis unit 13, the offense determining unit 15, the license plate recognition unit 77 and the data output unit 17. The image input unit 11 is used to acquire the image of the lane to be monitored. The image analysis unit 13 is used to analyze and extract the type and position information of detected vehicles from the image sequence. The offense determining unit 15 is used to determine if any traffic violation occurs. The license plate recognition unit 77 is used to recognize the plate number of the detected vehicle. Furthermore, the data output unit 17 outputs the images of the violating vehicle and the violating vehicle's license plate recognized by the license plate recognition unit 77.

After the image input unit 11 acquires the monitoring image, the image analysis unit 13 then analyzes the image and extracts the position and type of vehicles through image analysis schemes. Furthermore, the offense determining unit 15 may determine whether the detected vehicle violates any traffic regulation according to the traffic regulation, the predefined detection zone and the information of position and the type of vehicle. After that, the license plate recognition unit 77 then recognizes the license plate. The information will be inputted to the data output unit 17. The data output unit 17 accordingly outputs the image and plate number of the violating vehicle. These data can be employed to report the violation. For example, the system can be implemented as an automatic ticketing system of traffic violation by using the results of license plate recognition.

Reference is made to FIG. 8, which illustrates an operational flow chart for the automatic traffic violation detection system in accordance with the instant disclosure. Refer to FIG. 1, the shown system includes the image input unit 11, the image analysis unit 13, the offense determining unit 15 and the event tagging unit 87. The image input unit 11 is used to acquire the image of a specific monitored lane. Furthermore, the image analysis unit 13 is to analyze and extract the type and position of the vehicle from the taken image sequence. The offense determining unit 15 is used to determine whether any traffic violation occurs in the image. In particular, an event tagging unit 87 is incorporated to tag the information. Those tags can be the location of the violation, taken place, date, time and the type of the violation, and other information thereto.

Since the monitoring image is acquired by the image input unit 11, the image is transmitted to the image analysis unit 13. By means of image analysis schemes, the system can extract the type and position of vehicles from the image sequence. Based on the recognized vehicle type and position, the offense determining unit 15 then determines if any violation occurs in the image according to the traffic regulation and the predefined detection zone. If an event of traffic violation is determined, the event tagging unit 87 may tag the traffic violation as an event and the data of date, time, location and the type of violation are tagged. The tagged information is particularly recorded in event tagged data. After the further analysis or filtering, the user may quick search any traffic violation event recorded in the event tagged data.

It is worth noticing that the detection system, in one of the embodiments, includes the image input unit, the image analysis unit, the offense determining unit, the license plate recognition unit and the event tagging unit. In one further embodiment, the system includes the image input unit, the image analysis unit, the offense determining unit, the license plate recognition unit, the event tagging unit, and an output unit.

The implement of the mentioned event tagged data can be exemplarily shown as follows:

<event 1><Min-quan East Rd. site 1><Sep. 5, 12:30:25><(car) runs on (bus-only lane)><monitoring-image01.avi><01:21:05.02>

<event 2><Min-quan East Rd. site 3><Sep. 6, 07:25:09><(scooter) runs on (scooter-prohibited lane)><monitoring-image02.avi><02:07:23.15>

<event 3><Min-quan East Rd. site 1><Sep. 6, 12:46:16><(car) runs on (bus-only lane)><monitoring-image01.avi><01:36:56.22>

<event 4><Zhong-xiao East Rd. site 2><Sep. 6, 19:32:11><(car) occupies (scooter-waiting zone)><monitoring-image04.avi><05:12:11.08>

<event 5><Da-zhi bridge 1><Sep. site 7, 15:26:40><(car) runs on (scooter-only lane)><monitoring-image03.avi><01:29:33.11>

<event 6><Da-zhi bridge 1><Sep. site 7, 16:09:32><(car) runs on (scooter-only lane)><monitoring-image03.avi><02:12:25.26>

<event 7><Zhong-xiao East Rd. site 2><Sep. 7, 20:45:38><(scooter) occupies (bus-stop zone)><monitoring-image04.avi><06:25:38.27>

<event 8><Dun-hua South Rd. site 3><Sep. 8, 08:57:27 scooter) runs on (scooter-prohibited lane)><monitoring-image02.avi><03 :39:41.15>

The above description is regarding to the event-tagged data made by the event tagging unit of the automatic traffic violation detection system. The example shows the content of each event tagged data exemplarily includes, but not limited to the practical usage, a serial number, location, date, time, event type, the video/image filename, and the time stamp in the recorded video.

The mentioned location tag of the event is to locate the traffic violation, and the location indicates the site where the camera is mounted. The date and time tags illustrate the date and time when the traffic violation is detected. The type tag is used to describe the type of the traffic violation. The corresponding video/image filename and the time stamp of filing tags are provided for users to search the video or image regarding the traffic violation. It is noticed that the mentioned types of the traffic violations exemplarily include car running on the bus-only lane, scooter running on the scooter-prohibited lane, car running on the scooter-only lane, car occupying the scooter-waiting zone, and scooter occupying the bus-stop zone.

While the above description constitutes the preferred embodiment of the instant disclosure, it should be appreciated that the invention may be modified without departing from the proper scope or fair meaning of the accompanying claims. Various other advantages of the instant disclosure will become apparent to those skilled in the art after having the benefit of studying the foregoing text and drawings taken in conjunction with the following claims.

What is claimed is:

1. An automatic traffic violation detection system, comprising:
an image input unit for acquiring an image;
an image analysis unit, connected to the image input unit, for analyzing types and positions of one or more vehicles extracted from the image sequence;
an offense determining unit, connected to the image analysis unit, for determining if there is any violating vehicle in the image; and
a data output unit, connected to the offense determining unit, for outputting the data with one or more violating vehicles determined by the offense determining unit.

2. The system of claim 1, wherein the image input unit is a camera, an image output equipment, or a combination of any number of the camera and the equipment.

3. The system of claim 2, wherein the camera is a wide-angle camera, a license plate camera, or a combination of any number of the wide-angle camera and license plate camera.

4. The system of claim 2, wherein the image output equipment is a digital camera, a digital video recorder, a video player or digital image files.

5. The system of claim 1, wherein the data output unit is a storage device, a display device, a data transmission equipment, or a combination of any number of the storage device, the display device, and the data transmission equipment.

6. The system of claim 1, wherein the image analysis unit comprises a vehicle position detection sub-unit for extracting the position and movement information of the vehicle from the image sequence.

7. The system of claim 6, wherein the vehicle position detection sub-unit divides the image into sub-blocks based on the color, and estimates the motion vector of each sub-block; when a distance between the sub-blocks is smaller than a threshold and the motion vectors of these sub-blocks are similar, the related plurality of sub-blocks are merged into an image object; if the image object is judged as a vehicle, the related position and movement information are acquired.

8. The system of claim 6, wherein the vehicle position detection sub-unit extracts a vehicle image according to a difference between the current image and a background image, and further acquires the position and movement information of the vehicle.

9. The system of claim 1, wherein the image analysis unit comprises a vehicle-type recognition sub-unit for identifying the type of extracted vehicle such as a scooter, a car or a bus.

10. The system of claim 9, wherein the vehicle-type recognition sub-unit classifies the recognized vehicle according to the vehicle's aspect ratio, moving speed and contour.

11. The system of claim 10, wherein the scooter is identified since the vehicle image of extracted object has large aspect ratio and occupies a smaller area; the car is identified since the extracted object has small aspect ratio and higher moving speed.

12. The system of claim 9, wherein the vehicle-type recognition sub-unit recognizes the object type based on matching to the template of a scooter, a car or a bus.

13. The system of claim 1, wherein the system is to detect the traffic offense as a specific vehicle traveling on a prohibited lane after the type of the vehicle is recognized.

14. The system of claim 1, wherein the system is to detect the traffic offense as a general vehicle parking on a no-parking zone after the vehicle is detected as the general vehicle.

15. The system of claim 1, wherein the system further comprises a license plate recognition unit for recognizing a license plate of the violating vehicle.

16. The system of claim 1, wherein the system further comprises an event tagging unit for tagging date, time, location, the type of traffic offense and related information in the image.

17. The system of claim 16, wherein an event tagged data outputted from the event tagging unit is provided with the benefit of hindsight analysis or filtering of a monitoring image, and to quick search the traffic offenses.

18. The system of claim 17, wherein the event tagged data includes a serial number, date, time, location, event type, a related filename, and the time stamp in the recorded video of the violating event.

19. An automatic detection method of traffic violation, comprising:
establishing a condition-setting data group, at least including a predefined detection zone and vehicle-type information;
defining a condition of determination with respect to the detection zone and the vehicle type from the condition-setting data group;
receiving a taken image, and determining one or more vehicles in the image by an image analysis process;
receiving position information and the vehicle-type information from the determined vehicle information;
determining whether the vehicle enters the detection zone according to the condition of determination;
determining no traffic violation if the vehicle does not enter the detection zone;
if the vehicle enters the detection zone, determining whether the vehicle is the type prohibited to enter the detection zone according to the vehicle-type information;
if the vehicle is the prohibited type, it is determined as a traffic violation event; and
if the vehicle is not the prohibited, it is determined no traffic violation.

20. An automatic detection method of traffic violation, comprising:
establishing a condition-setting data group, at least including a detection zone and vehicle-type information;
defining the detection zone and condition of determination with respect to a vehicle's type from the condition-setting data group;
receiving a taken image, and determining one or more vehicle images by an image analysis process;
receiving position information and vehicle-type information from the vehicle images;
determining whether the vehicle is an illegal type occupying or parking the detection zone according to the defined detection zone and a parking time limit;
if the vehicle is not the illegal type, it is determined there is no traffic violation;
if the vehicle is the illegal type, it determines whether the vehicle enters the detection zone;
if the vehicle does not enter the detection zone, it is determined there is no traffic violation;
if the vehicle enters the detection zone, it determines whether the vehicle occupies or parks on the detection zone over the predefined period;
if the time of the vehicle occupies or is parked on the detection zone exceeds the predefined period, it is determined the vehicle causes traffic offense; and
if the time does not exceeds the predefined period, it is determined there is no traffic violation.
